(19) United States
(12) Patent Application Publication
(10) Pub. No.: US 2020/0264126 A1
(43) Pub. Date: Aug. 20, 2020

(54) ELECTROCHEMICAL MEASUREMENT METHOD AND SYSTEM

(71) Applicant: National Central University, Taoyuan City (TW)

(72) Inventor: Chen-Han HUANG, Taoyuan City (TW)

(21) Appl. No.: 16/788,705

(22) Filed: Feb. 12, 2020

(30) Foreign Application Priority Data
Feb. 15, 2019 (TW) 108105149

(51) Int. Cl. G01N 27/416; G01N 27/327; B01L 3/00

(52) U.S. Cl. CPC G01N 27/416; G01N 27/3276; B01L 2300/06; B01L 2300/0645; B01L 3/5085

(57) ABSTRACT

The present invention provides an electrochemical measurement method in which a plurality of samples comprising an analyte is respectively placed in a sensing chip with a plurality of wells. Since each of the wells is independently provided with an electrode and a labeled molecule, each of the plurality of samples generates a sensing signal after contacting the labeled molecule, and then the sensing signal in each of the plurality of wells is processed by a circuit disposed in each of the wells to correspondingly output the sensing signal, so that different analytes are independently analyzed in a single test to effectively improve the efficiency of electrochemical analysis.

### FIELD OF THE INVENTION

The present invention relates to an electrochemical measurement method and system, and more particularly to a high-flux electrochemical measurement method and system applicable to biological and chemical detection.

### BACKGROUND OF THE INVENTION

Electrochemical analysis mainly uses the potential, current and/or resistance of the sample to analyze the composition and concentration of the analyte in the sample. Currently, electrochemical analysis is mainly used in chemical and biomedical related tests. Because this detection method is able to greatly reduce the demand for equipment, reduce the cost, and also improve the mobility, so that the detection is no longer limited to be performed in the laboratory. The above reasons make electrochemical analysis an important milestone in the development of modern analytical systems.

For example, U.S. Pat. No. 6,100,045 discloses a method for detecting of analytes by using electrochemistry. In a preferred embodiment, a sample is firstly mixed with a molecule having a binding affinity to an analyte in the sample, wherein a label such as an enzyme is provided on the molecule; then a conjugate of the labeled molecule and the analyte is immobilized on a solid phase near a working electrode, rinsed with a solution, and a substrate solution is provided to enable the label (e.g. enzyme) to generate an electrical signal that can be detected by the working electrode.

Although the prior art described above can greatly improve the speed and sensitivity of detection, there is still a drawback that only one type of analyte can be analyzed in a single detection. In view of this, there is still a need for continuous improvement in the related fields to further enhance the efficiency of electrochemical analysis techniques.

### SUMMARY OF THE INVENTION

One object of the present invention is to solve the drawback of the conventional electrochemical measurement method that only one type of analyte is capable of being analyzed in a single detection.

Another object of the present invention is to improve the efficiency of electrochemical analysis by analyzing a plurality of different analytes in a single test.

In order to achieve the above objects, an embodiment of the present invention provides an electrochemical measurement method, comprising:
placing a plurality of samples in a sensing chip with a plurality of wells to allow each of the plurality of wells correspondingly comprises one of the plurality of samples, wherein each of the plurality of samples comprises an analyte, and each of the plurality of wells is independently provided with an electrode and at least one labeled molecule, so that each of the plurality of samples contacts with the labeled molecule to generate a sensing signal; and processing the sensing signal by a circuit disposed in each of the plurality of wells to correspondingly output a first sensing signal after the electrode in each of the plurality of wells detects the sensing signal.

In one embodiment, the electrochemical measurement method further comprises processing the first sensing signal by a multiplex detection circuit to convert the first sensing signal into a second sensing signal which is stored or read by a processor-containing device.

Another embodiment of the present invention also provides an electrochemical measurement system comprising a sensing chip and a plurality of circuits. The sensing chip comprises a multi-well baseplate with a plurality of wells and an electrode array, the electrode array comprises a plurality of electrodes. Each of the plurality of wells of the multi-well baseplate is correspondingly provided with at least one electrode. Each of the electrodes comprises a reference electrode, an auxiliary electrode and a working electrode. Further, the plurality of circuits are respectively disposed in the plurality of wells, and each of the plurality of circuits comprises a first amplifier coupled to the reference electrode and the working electrode of each of the plurality of wells to amplify an output power of the reference electrode and the working electrode, and a second amplifier coupled to the auxiliary electrode of each of the plurality of wells to amplify an output power of the auxiliary electrode.

In one embodiment, the electrochemical measurement system further comprises a multiplex detection circuit. The multiplex detection circuit comprises a multiplexer coupled to the circuit, an analog-to-digital converter coupled to the multiplexer, and a controller coupled to the analog-to-digital converter.

The method and the system provided by the present invention are able to independently perform signal measurement on more than one type of analyte to realize high-flux multiplex electrochemical sensing, and the obtained signals is further processed, connected to the controller, and stored and read by a computer or a smart device via wired or wireless transmission. Compared with the conventional electrochemical measurement method and system that only analyze a single type of analyte in a single detection, the invention can greatly improve the analysis efficiency and improve the accuracy of the analysis by the processed detection signals. Besides, the applications of the invention are more flexible because they are compatible with computers or smart devices.

### BRIEF DESCRIPTION OF THE DRAWINGS

FIG. 1 is a schematic view of the operation of an electrochemical measurement system according to an embodiment of the present invention;

FIG. 2A is an exploded view of the composition of a sensing chip of FIG. 1;

FIG. 2B is an overall view of the sensing chip of FIG. 2A;

FIG. 2C is a schematic view of an electrode array of FIG. 2A;

FIG. 2D is a schematic view of an electrode of FIG. 2C;

FIG. 3 is a schematic view of a circuit, a driving circuit, a transmission device, and a processor-containing device according to an embodiment of the present invention;

FIG. 4A and FIG. 4B are cyclic potential results for detecting the reversible reaction of Fe(CN)₆³⁻/Fe(CN)₆⁴⁻ according to a first embodiment of the present invention; and

FIG. 5A and FIG. 5B are experimental results of immunoassay for detecting protein kinase of different concentrations by constant voltage and current according to a second embodiment of the present invention.

### DETAILED DESCRIPTION OF THE PREFERRED EMBODIMENTS

The detailed description and technical content of the present invention will now be described with reference to the accompanying drawings as follows.

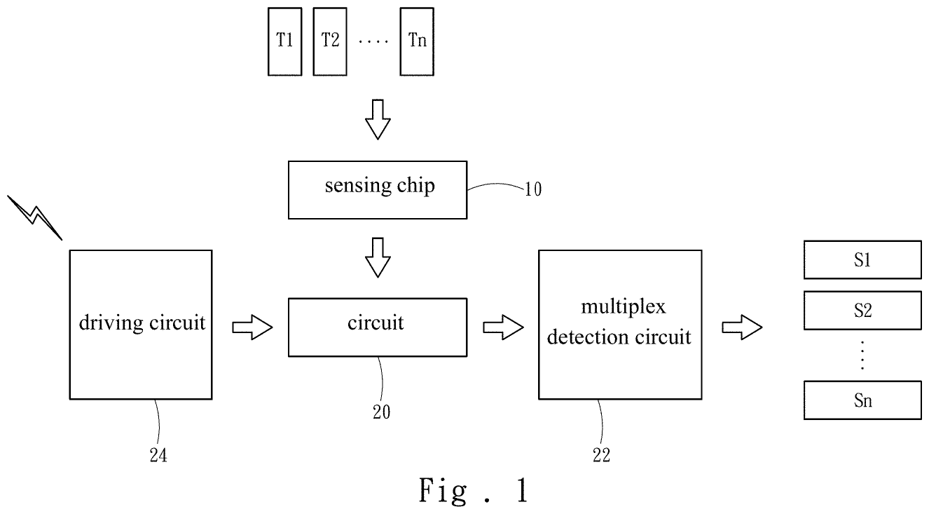

FIG. 1 is a schematic view of the operation of an electrochemical measurement system according to an embodiment of the present invention. The electrochemical measurement system of the present embodiment mainly comprises a sensing chip 10, a circuit 20, and a multiplex detection circuit 22.

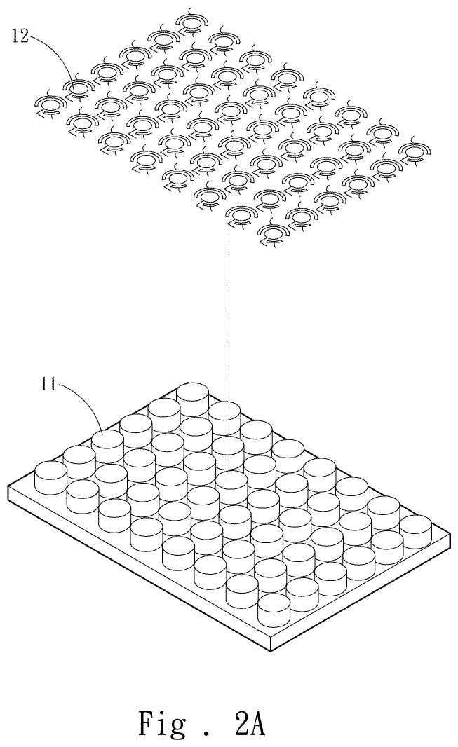

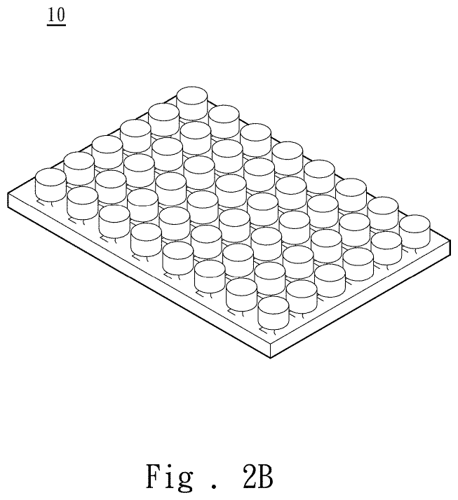

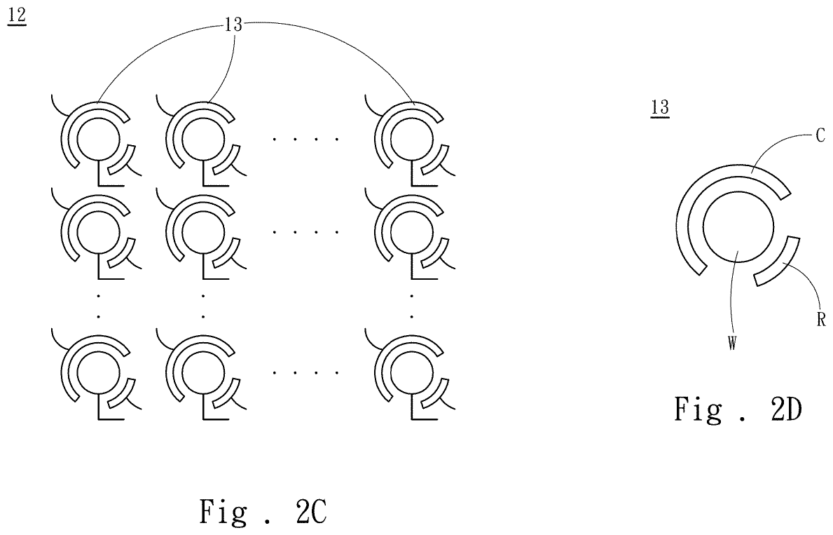

Referring to FIG. 2A and FIG. 2B, the sensing chip 10 comprises a multi-well baseplate 11 and an electrode array 12.

The multi-well baseplate 11 is a multi-well plate with a plurality of wells or a baseplate with a plurality of microfluidic channels. The materials are commonly used in glass or plastics, and are not particularly limited. A partition wall is formed between any one of the plurality of wells and the adjacent well, or between any one of the microfludic channels and the adjacent microfludic channel on the multi-well baseplate 11, so as to avoid errors caused by mixing of samples with one another during the detection analysis. As shown in FIG. 2C, the electrode array 12 comprises a plurality of electrodes 13 such that at least one electrode 13 is correspondingly disposed in each of the plurality of wells of the multi-well baseplate 11. Please refer to FIG. 2D,each of the plurality of electrodes 13 comprises a reference electrode R, an auxiliary electrode C, and a working electrode W. Materials suitable for use in the plurality of electrodes of the present invention include metals such as gold, silver, platinum, copper, or non-metallic conductive materials such as carbon.

In this embodiment, a multi-well plate with a plurality of wells is used as the multi-well baseplate 11, and one of the electrodes 13 which comprises the reference electrode R, the auxiliary electrode C, and the working electrode W is correspondingly disposed in each of the plurality of wells of the multi-well baseplate 11.

Each of the plurality of wells is modified with a labeled molecule according to the type of the analyte to be detected. Any molecule commonly used as a label in the prior art may be used in the present invention, for example, a specific antigen or antibody is able to be immobilizing in the channel Alternatively, a plurality of magnetic beads with specific antibodies can be used in other embodiments, and the plurality of magnetic beads are concentrated and aggregated in the vicinity of the working electrode W by a magnet for detection during measurement and analysis.

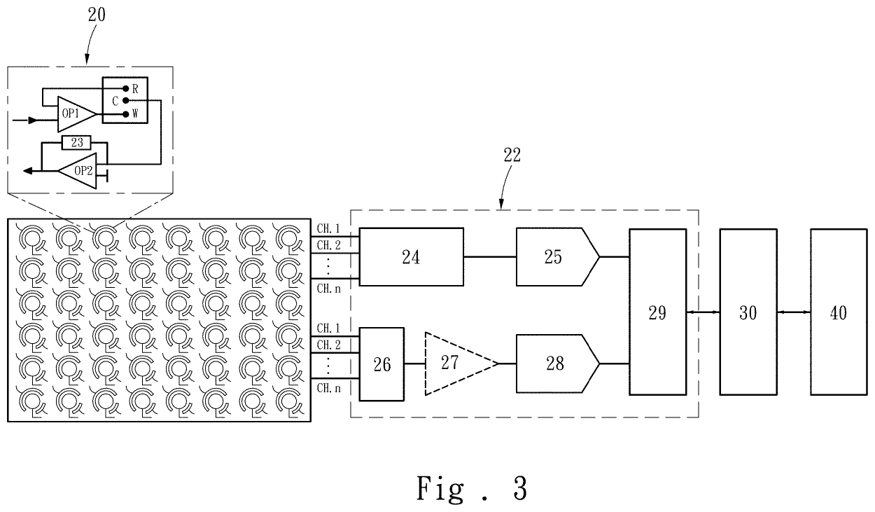

Regarding the circuit 20 and the multiplex detection circuit 22, please refer to FIG. 3.

Each of the plurality of wells comprises one circuit 20. Each of the circuits 20 comprises a first amplifier OP1 respectively coupled to the reference electrode R and the working electrode W of each of the plurality of wells to amplify an output power of the reference electrode R and the working electrode W, and a second amplifier OP2 coupled to the auxiliary electrode C of each of the plurality of wells to amplify an output power of the auxiliary electrode C. In this embodiment, the second amplifier OP2 can be further connected to a resistor 23 in parallel.

The multiplex detection circuit 22 comprises a multiplexer 26, an analog-to-digital converter 28, and a controller 29, wherein the multiplexer 26 is coupled to the circuit 20, the analog-to-digital converter 28 is coupled to the multiplexer 26, the controller 29 is coupled to a digital-to-analog converter 25, the digital-to-analog converter 25 is coupled to a driving circuit 24, and the driving circuit 24 is coupled to the circuit 20. Accordingly, the controller 29 transmits a programmed control driving signal, outputs an analog control signal via the digital-to-analog converter 25, and then maintains a stable voltage through the driving circuit 24 to be outputted to each of the plurality of wells, thereby avoiding errors of the measuring signal of each of the plurality of wells. On the other hand, the controller 29 is also coupled to the analog-to-digital converter 28 and the multiplexer 26, and the multiplexer 26 is coupled to the circuit 20, so that the signals from the circuit 20 can be processed by the multiplexer 26 and the analog-to-digital converter 28, and then transmitted to the controller 29. In this embodiment, in order to adjust the strength of the signals outputted by the multiplexer 26, a programmable amplifier 27 can be further disposed between the multiplexer 26 and the analog-to-digital converter 28. Since the programmable amplifier is respectively coupled to the multiplexer 26 and the analog-to-digital converter 28, the signals outputted by the multiplexer 26 are amplified and inputted to the analog-to-digital converter 28.

Further, each of the signals inputted to the analog-to-digital converter 28 can be converted into a second sensing signal, and the second sensing signal is stored or read by a processor-containing device 40. Specifically, in this embodiment, the signals enter the controller 29 from the analog-to-digital converter 28, and are transmitted to the processor-containing device 40 via a wired or wireless transmission device 30, such as wireless network or Bluetooth. The processor-containing device 40 described above can be, for example, a computer, a smartphone, or a tablet.

Through the above electrochemical measurement system, high-flux electrochemical measurement analysis can be easily performed.

Please refer to FIG. 1 and FIG. 3. Firstly, the samples are respectively placed into the sensing chip 10 with the plurality of wells, so that each of the plurality of wells of the sensing chip 10 corresponds to one of the samples. Each of the above samples independently includes different analytes T1, T2, Tn, and the like.

When the sample is placed in each of the plurality of wells and contacts the labeled molecule, a sensing signal is generated since each of the plurality of wells is independently provided with one of the plurality of electrodes 13 and at least one labeled molecule has been correspondingly immobilized or disposed in each of the wells before the detection analysis is performed. After the electrode 13 in each of the plurality of wells detects the sensing signal, the sensing signal is processed by the circuit 20 disposed in each of the plurality of wells to output a corresponding first sensing signal. In this embodiment, the amount of wells is “n”. The sensing chip 10 generates the maximum n different first sensing signals CH.1, CH.2 to CH.n through the circuit 20 of each of the plurality of wells.

The first sensing signals from the different wells are then transmitted to the multiplex detection circuit 22 and converted into a plurality of second sensing signals S1, S2 to Sn that are stored or read by the processor-containing device 40. The processed second sensing signals are not only more accurate in the subsequent analysis of data, but are also compatible with the processor-containing device 40 such as a computer or a smart device to make the application more flexible.

First Embodiment

In the first embodiment, reversible reaction of Fe(CN)₆³⁻/Fe(CN)₆⁴⁻ (potassium ferricyanide) is practically detected and verified by the electrochemical measurement system and method described above. Cyclic voltammetry is used to scan the positive and negative potentials, and the reaction current is detected; a potential/current correlation curve is obtained, and a corresponding current density curve is obtained through different potential scanning speeds.

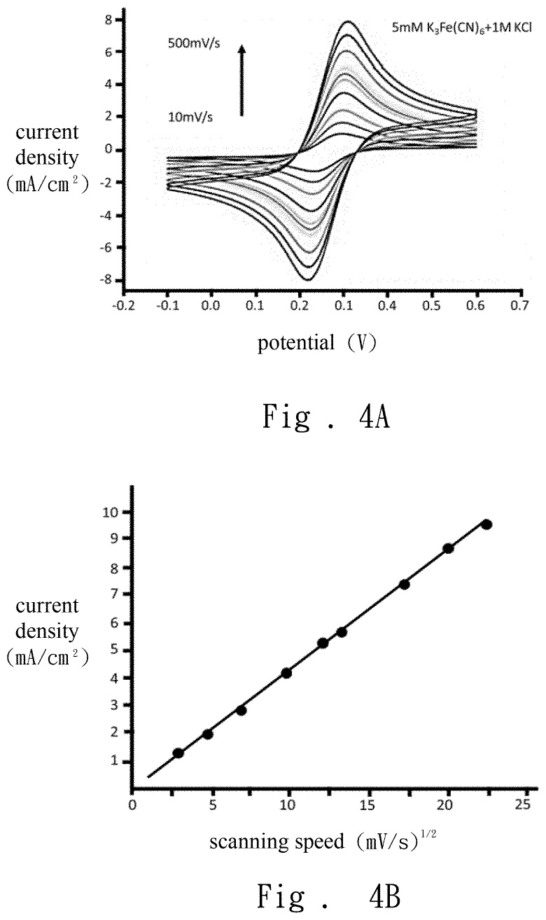

For the test results, please refer to FIG. 4A and FIG. 4B. It can be observed from the results of the cyclic potential that stable measurement results can be obtained by the electrochemical measurement system and method of the present invention.

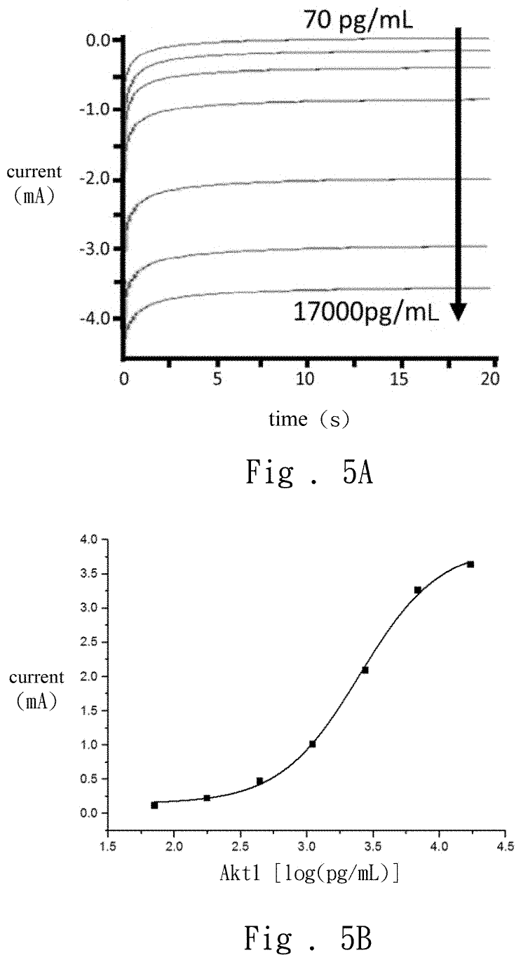

Second Embodiment In the second embodiment of the present invention, the above-mentioned electrochemical measurement system and method are used to perform immunoassay tests on protein kinase Akt1 of different concentrations. For the test results, please refer to FIG. 5A and FIG. 5B. When the current of the protein kinase Akt1 at a concentration of 70 pg/mL to 17,000 pg/mL is measured at a constant voltage, stable measurement results can be obtained.

In summary, the present invention is able to detect every signal in the plurality of wells independently through the electrochemical measurement system and method with the multi-well detection network. Therefore, the high-flux measurement method for measuring a plurality of different analytes in one experiment can be realized. Further, the setting of the multiplex detection circuit is used to process the signals so that the detection signals are compatible with computers or smart devices, and the applicability of the detection signals is more extensive.

What is claimed is:

1. An electrochemical measurement method, comprising:
placing a plurality of samples in a sensing chip with a plurality of wells to allow each of the plurality of wells correspondingly comprises one of the plurality of samples, wherein each of the plurality of samples comprises an analyte, and each of the plurality of wells is independently provided with an electrode and at least one labeled molecule, so that each of the plurality of samples contacts with the labeled molecule to generate a sensing signal; and
processing the sensing signal by a circuit disposed in each of the plurality of wells to correspondingly output a first sensing signal after the electrode in each of the plurality of wells detects the sensing signal.

2. The electrochemical measurement method as claimed in claim 1, further comprising processing the first sensing signal by a multiplex detection circuit to convert the first sensing signal into a second sensing signal which is stored or read by a processor-containing device.

3. The electrochemical measurement method as claimed in claim 1, wherein the labeled molecule is an antigen, an antibody, or a magnetic bead attached with an antibody.

4. The electrochemical measurement method as claimed in claim 1, wherein the electrode comprises a reference electrode, an auxiliary electrode and a working electrode, and the circuit comprises a first amplifier for amplifying an output power of the reference electrode and the working electrode, and a second amplifier for amplifying an output power of the auxiliary electrode.

5. The electrochemical measurement method as claimed in claim 2, wherein the multiplex detection circuit comprises a multiplexer coupled to the circuit, an analog-to-digital converter coupled to the multiplexer, and a controller coupled to the analog-to-digital converter.

6. The electrochemical measurement method as claimed in claim 2, wherein the processor-containing device is a computer, a smart phone, or a tablet.

7. An electrochemical measurement system, comprising:
a sensing chip, comprising a multi-well baseplate with a plurality of wells and an electrode array, the electrode array comprising a plurality of electrodes, each of the plurality of wells of the multi-well baseplate correspondingly provided with at least one of the plurality of electrodes, wherein each of the plurality of electrodes comprises a reference electrode, an auxiliary electrode, and a working electrode; and
a plurality of circuits, respectively located in the plurality of wells, each of the plurality of circuits comprising a first amplifier coupled to the reference electrode and the working electrode of each of the plurality of wells to amplify an output power of the reference electrode and the working electrode, and a second amplifier coupled to the auxiliary electrode of each of the plurality of wells to amplify an output power of the auxiliary electrode.

8. The electrochemical measurement system as claimed in claim 7, further comprising a multiplex detection circuit, wherein the multiplex detection circuit comprises a multiplexer coupled to the plurality of circuit, an analog-to-digital converter coupled to the multiplexer, and a controller coupled to the analog-to-digital converter.

9. The electrochemical measurement system as claimed in claim 8, wherein the multiplex detection circuit further comprises a programmable amplifier, the programmable amplifier is coupled to the multiplexer and the analog-to-digital converter to amplify signals outputted by the multiplexer and input the signals to the analog-to-digital converter.

10. The electrochemical measurement system as claimed in claim 7, wherein each of the plurality of wells further comprises at least one labeled molecule.
